(19) United States
(12) Patent Application Publication
(10) Pub. No.: US 2006/0250365 A1
(43) Pub. Date: Nov. 9, 2006

(54) Computer input device

(76) Inventor: Chien-Chun Yu, Taipei County (TW)

Correspondence Address: BACON & THOMAS, PLLC, 625 SLATERS LANE, FOURTH FLOOR, ALEXANDRIA, VA, 22314, US

(21) Appl. No.: 11/366,440

(22) Filed: Mar. 3, 2006

(30) Foreign Application Priority Data
May 9, 2005 (TW) 94207438

(51) Int. Cl. G09G 5/08

(52) U.S. Cl. 345/163

(57) ABSTRACT

A computer input device includes a cursor control device for controlling the positioning of a cursor on a screen of a computer, a handwriting input member installed in the cursor control device for handwriting input with an input pen, operation buttons, and a selection switch switchable between a first mode position for allowing operation of the operation buttons to control the operation of the cursor control device and a second mode position for allowing operation of the operation buttons to control the operation of the handwriting input member.

### BACKGROUND OF THE INVENTION

1. Field of the Invention

The present invention relates to an input device for computers and more particularly, to a computer input device that provides a cursor positioning function as well as a signature-writing function.

2. Description of the Related Art

Following fast development of information technology and wide application of the Internet, many paper data are digitalized/electronized for transmission between computers and storage in data storage means so that storage data can be transferred easily and rapidly to any place where a computer is connectable to the Internet.

Data digitalization/electronization has many advantages. However, digitalized/electronized data can easily be duplicated. The way of using paper to record data provides an exclusive original copy. It is difficult to duplicate a handwriting copy. Having digitalized data to be the exclusive original copy is a problem to solve. Currently, the way of handling confidential official documents or business letters is to edit the data through a computer, and then to print the data on paper, and then to sign the name of the person in charge on the printed paper, and then use a fax machine or scanner to transfer the well signed paper into digital data.

The aforesaid procedure of handling confidential data is complicated, and an error or waste of paper may occur during the procedure, thereby affecting the promotion of data digitalization and paper-free documentation.

### SUMMARY OF THE INVENTION

The present invention has been accomplished under the circumstances in view. It is the main object of the present invention to provide a computer input device, which provides a cursor positioning function as well as a signature-writing function.

To achieve this object of the present invention, the computer input device comprises a cursor control device, a handwriting input member, at least one button, and a selection switch. The cursor control device is connectable to a computer for controlling the positioning of a cursor on a screen and has at least one displacement sensor for detecting the direction and amount of movement of the cursor control device on a surface. The handwriting input member is installed in the cursor control device for inputting the user's handwriting into the computer to which the cursor control device is connected. The at least one button is electrically connected to the cursor control device and the handwriting input member. The selection switch is electrically connected to the cursor control device and the handwriting input member. The selection switch is switchable between a first mode position and a second mode position. When the selection switch is switched to the first mode position, the at least one button is operable to control the operation of the cursor control device in controlling the positioning of the cursor on the screen of the computer to which the cursor control device is connected. When the selection switch is switched to the second mode position, the at least one button is operable to control the operation of the handwriting input member for inputting a handwriting into the computer to which the cursor control device is connected.

### BRIEF DESCRIPTION OF THE DRAWINGS

FIG. 1 is a perspective view of a computer input device according to a preferred embodiment of the present invention.

FIG. 2 is a side view of the preferred embodiment of the present invention, showing the selection switch switched to the first mode position.

FIG. 3 is a sectional view of the computer input device according to the preferred embodiment of the present invention.

FIG. 4 is another side view of the preferred embodiment of the present invention, showing the selection switch switched to the second mode position.

FIG. 5 is a schematic drawing of the present invention, showing the user's signature written on the handwriting input member.

### DETAILED DESCRIPTION OF THE INVENTION

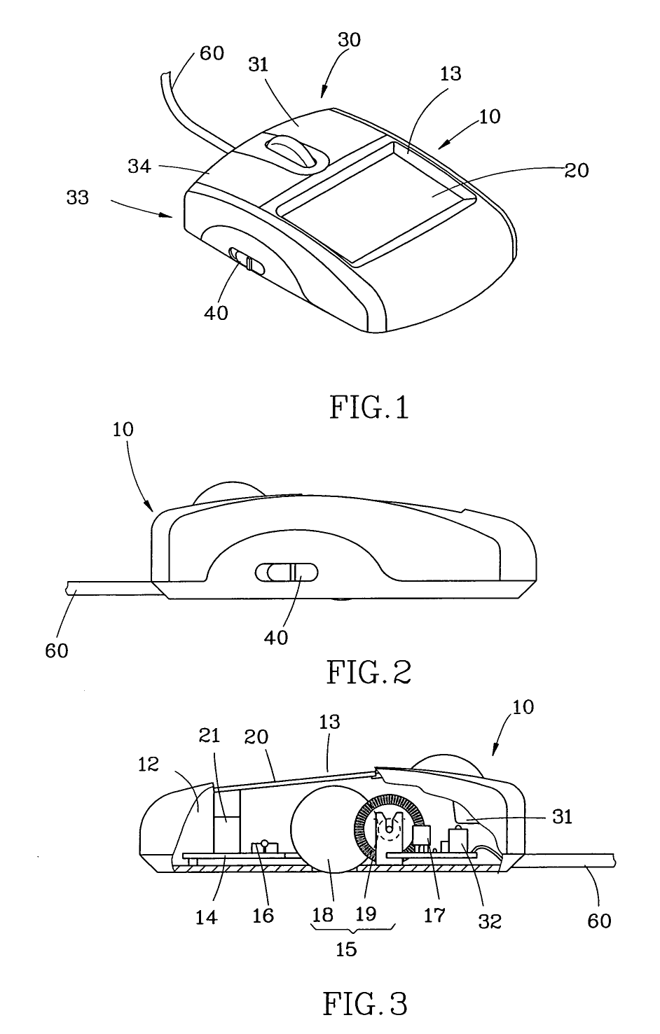

As shown in FIGS. 1-3, a computer input device in accordance with the preferred embodiment of the present invention comprises a cursor control device 10, a handwriting input member 20, a first button 30, a second button 33, and a selection switch 40.

The cursor control device 10 defines an accommodation chamber 12. The cursor control device 10 further has an opening 13 cut through the top wall in communication with the accommodation chamber 12. The accommodation chamber 12 accommodates a circuit board 14 and a rolling device 15. The circuit board 14 has electronic components 16 and at least one displacement sensor 17. The rolling device 15 comprises a rolling ball 18 and at least one grating 19. The number of the at least one grating 19 is equal to the number of the at least one displacement sensor 17. According to this embodiment, cach displacement sensor 17 is a photoelectric induction switch. The rolling ball 18 has a part of the periphery projecting out of the bottom wall of the cursor control device 10. When moving the cursor control device 10 on the table top of a table, the rolling ball 18 is rotated in the cursor control device 10 on the same place, and the grating 19 is rotated with the rolling ball 18 to induce the displacement sensor 17, thereby causing the circuit board 14 to produce a signal indicative of the direction and amount of movement of the rolling ball 18 and to send the signal to the computer (not shown) through a signal line 60 to control the positioning of the cursor on the screen of the computer.

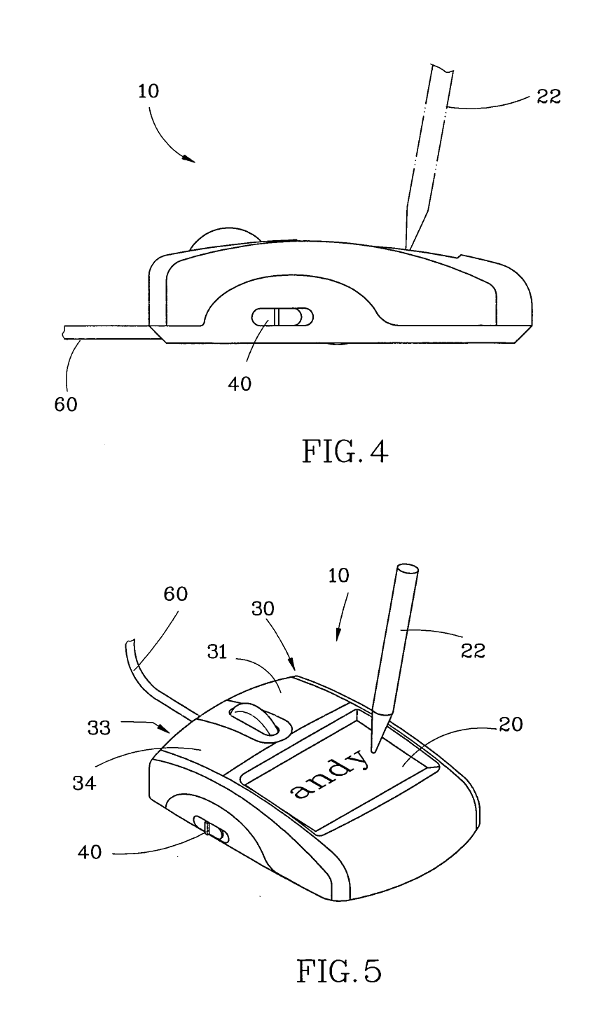

The handwriting input member 20 is a capacitive touch panel installed in the accommodation chamber 12 inside the cursor control device 10 at the top and exposed to the opening 13. The handwriting input member 20 is electrically connected to the circuit board 14 inside the cursor control device 10 through an electric connector 21. As shown in FIGS. 4 and 5, the handwriting input member 20 displays the handwriting of an input pen 22, and sends a signal indicative of the handwriting to the computer through the signal line 60.

The first button 30 comprises a spring member 31 and a micro switch 32. The spring member 31 is mounted on the cursor control device 10. The micro switch 32 is installed on the circuit board 14 inside the cursor control device 10 and electrically connected to the handwriting input member 20. The position of the micro switch 32 corresponds to the position of the spring member 31. Therefore, clicking the spring member 31 triggers the micro switch 32.

The second button 33 comprises a spring member 34 and a micro switch (not shown). The spring member 34 is mounted on the cursor control device 10. The micro switch of the second button 33 is installed on the circuit board 14 inside the cursor control device 10 and electrically connected to the handwriting input member 20. The position of the micro switch of the second button corresponds to the position of the spring member 34. Therefore, clicking the spring member 34 triggers the micro switch of the second button 33.

The selection switch 40 is an electronic switch electrically connected to the circuit board 14 inside the cursor control device 10 and the handwriting input member 20 through the circuit board 14. The selection switch 40 is selectable between a first mode position (see FIG. 2) and a second mode position (see FIG. 4). When switched the selection switch 40 to the first mode position as shown in FIG. 2, the first button 30 and the second button 33 are operable to control the operation of the cursor control device 10, i.e., to control the positioning of the cursor on the screen of the computer. When switched the selection switch 40 to the second mode position as shown in FIG. 4, the first button 30 and the second button 33 are operable to control the operation of the handwriting input member 20.

When using the computer input device of the present invention to proceed with a data editing work, the signal line 60 is connected to the computer, and then the selection switch 40 is switched to the first mode position, thereafter the cursor control device 10 is moved on the table top, enabling the displacement sensor 17 to detect the direction and amount of the movement of the cursor control device 10 so as to further control the positioning of the cursor on the screen of the computer. At this time, the user can operate the first button 30 and the second button 33 to execute a data editing work. If it is necessary to sign the user's name on the text during data editing, the user can move the cursor to the to-be-signed place to sign the user's name, and then switch the selection switch 40 to the second mode position as shown in FIG. 4. At this time, the user can use the input pen 22 to write the signature on the handwriting input member 20, enabling the handwriting input member 20 to display the signature. If the user feels satisfied with the style of the signature displayed on the handwriting input member 20, the user can then press the spring member 31 of the first button 30 to trigger the micro switch 32 of the first button 30, thereby inputting the signature into the computer through the circuit board 14 and the signal line 60, and therefore the signature is inputted into the data under editing. If the user does not accept the style of the signature displayed on the handwriting input member 20, the user can click the spring member 34 of the second button 33 to trigger the micro switch of the second button 33, thereby erasing the signature from the handwriting input member 20 for enabling the user to write the signature on the handwriting input member 20 again. Therefore, the signature displayed on the handwriting input member 20 is erasable. When the user feels satisfied with the signature displayed on the handwriting input member 20 and the signature is inputted from the handwriting input member 20 into the computer, the selection switch 40 is switched to the first mode position, enabling the cursor control device 10 to control the positioning of the cursor on the screen of the computer.

As indicated above, the invention has a handwriting input member incorporated into a cursor control device. Therefore, the computer input device of the present invention provides a cursor positioning function as well as a handwriting signature function, enabling the user to write the signature to the data when operating the computer.

Further, the cursor control device can be made to provide a penholder (not shown) for holding the input pen. When wishing the write the signature, the user can remove the input pen from the penholder conveniently. Further, optical encoder means or trackball may be used to substitute for the rolling device in detecting the direction and amount of movement of the cursor control device. A wireless signal transmission module may be used to substitute for the signal line for signal transmission from the computer input device to a computer. Further, a resistive touch panel may be used to substitute for the capacitive touch panel of the handwriting input member to achieve the same effect.

What is claimed is:

1. A computer input device comprising:
a cursor control device connectable to a computer for controlling the positioning of a cursor on a screen, said cursor control device having at least one displacement sensor for detecting the direction and amount of movement of said cursor control device on a surface;
a handwriting input member installed in said cursor control device for inputting a handwriting into the computer to which said cursor control device is connected;
at least one button electrically connected to said cursor control device and said handwriting input member; and
a selection switch electrically connected to said cursor control device and said handwriting input member and switchable between a first mode position and a second mode position;
wherein when said selection switch is switched to said first mode position, said at least one button is operable to control the operation of said cursor control device in controlling the positioning of the cursor on the screen of the computer to which said cursor control device is connected; when said selection switch is switched to said second mode position, said at least one button is operable to control the operation of said handwriting input member for inputting a handwriting into the computer to which said cursor control device is connected.

2. The computer input device as claimed in claim 1, wherein said cursor control device comprises an accommodation chamber, and an opening in communication with said accommodation chamber; said handwriting input member is mounted in said accommodation chamber of said cursor control device and exposed to said opening.

3. The computer input device as claimed in claim 1, wherein said cursor control device comprises a rolling device having a rolling ball and at least one grating movable with said rolling ball to induce said at least one displacement sensor for causing said at least one displacement sensor to detect the direction and amount of rotation of said rolling ball, the number of said at least one grating being equal to the number of said at least one displacement sensor.

4. The computer input device as claimed in claim 1, wherein said cursor control device comprises optical encoder means for enabling said at least one displacement sensor to detect the direction and amount of movement of said cursor control device on a surface.

5. The computer input device as claimed in claim 1, wherein said cursor control device comprises a trackball for enabling said at least one displacement sensor to detect the direction and amount of movement of said cursor control device on a surface.

6. The computer input device as claimed in claim 1, wherein said handwriting input member is a capacitive touch panel.

7. The computer input device as claimed in claim 1, wherein said handwriting input member is a resistive touch panel.

8. The computer input device as claimed in claim 1, further comprising an input pen for enabling the user to write on said handwriting input member, and a penholder fixedly provided at said cursor control device for holding said input pen.
